(19) United States
(12) Patent Application Publication
(10) Pub. No.: US 2026/0064619 A1
(43) Pub. Date: Mar. 5, 2026

(54) ADAPTIVE SOC ROUTING WITH DISTRIBUTED QUALITY-OF-SERVICE AGENTS

(71) Applicant: Akeana, Inc., Santa Clara, CA (US)

(72) Inventor: Yogesh Shamkant Thombre, Pleasanton, CA (US)

(73) Assignee: Akeana, Inc., Santa Clara, CA (US)

(21) Appl. No.: 19/313,925

(22) Filed: Aug. 29, 2025

Related U.S. Application Data
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.

(51) Int. Cl. G06F 13/40

(52) U.S. Cl. CPC G06F 13/4068

(57) ABSTRACT

Disclosed embodiments provide techniques for communication. A system-on-a-chip (SoC) is accessed. The SoC includes a mesh network that includes a plurality of nodes. At least one node within the plurality of nodes includes a quality-of-service (QoS) agent. Network traffic data is collected by a first QoS agent within a first node. The network traffic data is associated with the first node and the traffic occurs during a first timing window. The first QoS agent receives a request by a primary device within the first node to send data to a secondary device in a second node. The first QoS agent analyzes the network traffic data. A first routing agent within the first node selects an intermediate node within the plurality of nodes, based on the analyzing. The primary device sends the data to the intermediate node.

### RELATED APPLICATIONS

This application claims the benefit of U.S. provisional patent applications “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, and “In-Order Multithreading With Pipeline Flush And Instruction Replay” Ser. No. 63/870,916, filed Aug. 27, 2025.

Each of the foregoing applications is hereby incorporated by reference in its entirety.

### FIELD OF ART

This application relates generally to communication and more particularly to adaptive SoC routing with distributed quality-of-service agents.

### BACKGROUND

Electronic devices based on computer processors are widely used throughout society. The processors are found in computers and handheld devices, enabling browsing, applications, data processing, and communications equipment, thereby revolutionizing work, play, communication, and information access. The processors support connectivity and data processing, and have enabled the Internet of Things. The devices collect, analyze, and transmit data, promoting automation, remote monitoring and control, smart homes, medical devices, vehicles, and more. Processors enable communication and networking technologies to facilitate data transmission and network management. The processors are used in telecommunications infrastructure, mobile network equipment, and wireless devices, enabling seamless connectivity and communication. The processors are present in a wide array of consumer electronics beyond computers and smartphones. They are found in televisions, gaming consoles, digital cameras, home appliances, audio systems, wearables, and more. The processors enable advanced features, user interfaces, and connectivity options in these consumer devices. Processor versatility, scalability, and computational power have transformed industries by driving innovation and promoting technology advancements in numerous domains.

The foremost processor categories include Complex Instruction Set Computer (CISC) types and Reduced Instruction Set Computer (RISC) types. A CISC processor instruction may execute various operations. The operations can include loading from and storing to memory, arithmetic operations, logical operations, and so on. In a RISC processor, the instruction sets are smaller than the CISC instruction sets and may execute several operations in a pipelined manner. Pipeline stages can include fetch, decode, and execute. Each of these pipeline stages may take one clock cycle, and thus, the pipelined operation can allow RISC processors to operate on more than one instruction per clock cycle.

Integrated circuits (ICs) including processors are designed using a Hardware Description Language (HDL). Example HDLs include Verilog, VHDL, etc. HDLs support behavioral description, register transfer, gate, and switch level logic. HDLs enable designers to define system levels with varying detail. Behavioral level logic enables sequential instruction execution, while register transfer level logic describes data transfer between registers using a clock and gate level logic. An HDL enables text models that describe or express logic circuits. The models can be processed by a synthesis program, then tested using a simulation or emulation program. The design can include Register Level Transfer (RTL) abstractions that define the synthesizable data that is fed into a logic synthesis tool that creates the gate-level abstraction of the design used for downstream implementation operations.

The HDL tools enable the design and implementation of processors and other integrated circuits such as System-on-Chip (SoC) integrated circuits. SoC integrated circuits are highly versatile and find applications in a wide range of electronic devices and systems. These integrated circuits are designed to incorporate multiple components and functionalities onto a single chip, making them compact, power efficient, and cost effective. Processor performance enables a wide variety of applications, including data processing, virtualization, content creation, and security applications, to name a few. Thus, processer performance continues to be an important factor in the development of new systems and technologies.

### SUMMARY

The performance of one or more processors within devices directly impacts the capabilities and utility of devices that contain them. The devices include mobile and handheld devices, wearable devices, consumer electronics, automotive electronics, edge computing, and Internet of Things (IoT), to name a few. The processors can be classified based on their instruction sets, where the instruction sets include complex instruction sets or reduced instruction sets. One or more processors can be combined with additional functional blocks such as I/O controllers, memory controllers, and so on to form a system-on-chip (SoC). One or more processors within the SoC can be coupled by a mesh network structure. The mesh network structure can comprise one or more nodes that can comprise a network-on-chip (NoC). The mesh network structure can enable adaptive SoC data routing. The adaptive routing is enabled with one or more distributed quality-of-service (QoS) agents. The QoS agents can enable a route between non-adjacent nodes within the mesh network. One or more intermediate nodes can be selected to enable a route from the first node to the second node. The route can follow a cardinal direction from the first node to a second node, or any other direction such as a diagonal direction. The one or more intermediate nodes are selected based on analyzing network traffic data collected by the one or more QoS agents with the nodes. The selecting one or more intermediate nodes adaptive enables routes that exhibit lower latency to be selected, rather than other possible routes.

Disclosed embodiments provide techniques for communication. A system-on-a-chip (SoC) is accessed. The SoC includes a mesh network that includes a plurality of nodes. At least one node within the plurality of nodes includes a quality-of-service (QoS) agent. Network traffic data is collected by a first QoS agent within a first node. The network traffic data is associated with the first node and the traffic occurs during a first timing window. The first QoS agent receives a request by a primary device within the first node, to send data to a secondary device in a second node. The first QoS agent analyzes the network traffic data. A first routing agent within the first node selects an intermediate node within the plurality of nodes, based on the analyzing. The primary device sends the data to the intermediate node.

A processor-implemented method for communication is disclosed comprising: accessing a system-on-a-chip (SoC), wherein the SoC includes a mesh network, wherein the mesh network comprises a plurality of nodes, wherein at least one node within the plurality of nodes includes a quality-of-service (QoS) agent; collecting network traffic data, by a first QoS agent within a first node within the plurality of nodes, wherein the network traffic data is associated with the first node, and wherein the network traffic data occurs during a first timing window; receiving, by the first QoS agent, a request by a primary device within the first node to send data to a secondary device in a second node within the plurality of nodes; analyzing, by the first QoS agent, the network traffic data; selecting, by a first routing agent within the first node, an intermediate node within the plurality of nodes, wherein the selecting is based on the analyzing; and sending, by the primary device, the data to the intermediate node. In embodiments, the first node and the second node are non-adjacent within the mesh network. Some embodiments comprise forwarding the data from the intermediate node to the second node. In embodiments, the intermediate node is non-adjacent to the second node. Some embodiments comprise gathering additional network traffic data, by an intermediate QoS agent within the intermediate node, wherein the additional network traffic data is associated with the intermediate node, and wherein the additional network traffic data occurs during a second timing window.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for adaptive SoC routing with quality-of-service agents.

FIG. 2 is a flow diagram for sending data with quality-of-service agents.

FIG. 3 is a block diagram for a multicore processor.

FIG. 4 is a block diagram for a pipeline.

FIG. 5 is an example mesh network with switching units.

FIG. 6 is a block diagram of a switching unit.

FIG. 7 is an example of sending data from a primary device to a secondary device.

FIG. 8 is a system diagram for adaptive SoC routing of quality-of-service agents.

### DETAILED DESCRIPTION

Techniques for adaptive system-on-a-chip (SoC) routing with distributed quality-of-service (QoS) agents are disclosed. The SoC includes a mesh network that interconnects one or more nodes. The nodes can include one or more processors, cache coherency blocks (CCBs), coherent ordering agents (COAs), caches, memory controllers, input/output (I/O) controllers, and so on. Nodes within the mesh network can be coupled to send and receive data, provide status updates, and so on. The coupled nodes can communicate in cardinal directions, or in other directions such as a diagonal direction. Thus, nodes that are adjacent to a node can communicate directly, but non-adjacent nodes cannot. Instead, communication between non-adjacent nodes is enabled by selecting one or more intermediate nodes between the first node (which can be a primary node) and a second node (which can be a secondary node). The intermediate nodes are selected until an intermediate node that is adjacent to the second node is reached, thus enabling data sent from a primary device within the first node to reach a secondary device within the second node. The one or more intermediate nodes enable a route or path between the first node and the second node. Ideally, the intermediate nodes that are selected create a shortest and fastest route between the first node and the second node. However, the shortest route is not always the fastest route, nor, at times, even an available route. Traditional solutions can include arbitration to determine which node can obtain a needed bus between adjacent nodes to accomplish the needed communication. However, this can lead to execution stalls within the nodes as they must wait for data to be transferred/received to/from other nodes in the SoC. Lower overall performance of the SoC can result.

Disclosed embodiments include distributed QoS agents which can adaptively route SoC communications from the first node to the second node based on a knowledge of network traffic. The QoS agents can collect network traffic data and analyze the data. The traffic data collection occurs during a timing window and is accomplished by a QoS agent. The QoS agent analyzes the network traffic data to determine an estimated latency for sending data over the network. The analysis results from the QoS agent receiving a request to send data between nodes. A routing agent in the first node selects a first intermediate node. The selecting can be based on a low latency estimate. The primary device sends data to the first intermediate device. The intermediate device transmits the data to either the second node if the second node is adjacent to the intermediate device, or to an additional intermediate node. The additional intermediate node is picked based on examining additional network traffic data.

Data is routinely transferred between nodes within a system such as an SoC. The nodes can be executing processes, tasks, and so on, where there can be data dependencies between tasks. In a usage example, task B requires data that can be generated by task A, while task C does not have a data dependency with task A. Thus, task A must be executed prior to execution of task B, while task C can be executed in parallel with task A. Communication within a mesh network, such as a mesh network within the SoC, can be with nearest neighbors of a given node. Further, communication can be limited to cardinal directions from the node, such as with a node in each direction east, west, north, and south of the node. In some examples, the communication can include other directions such as a diagonal direction (e.g., northeast, southeast, southwest, and northwest) between nodes. Communication edge nodes and corner nodes can communicate with mesh nodes that are adjacent to them. Edge nodes and corner nodes may also communicate with data interfaces beyond the mesh network. Since communication can be limited only to adjacent nodes, when a first node communicates, such as sending data, with a second node, if the second node is non-adjacent to the first node, then one or more intermediate nodes can be used for transmitting data between the nodes, as discussed above. In order to find a viable route between the first node and the second node, QoS factors can be considered. In a usage example, a path with the lowest latency between the first node and the second node can be selected. The selecting a route based on latency can maximize data throughput and enhance data processing throughput.

Data is collected by a first QoS agent within a first node within a plurality of nodes within an SoC. The SoC includes a mesh network. The network traffic data is associated with the first node, and the network traffic data occurs during a first timing window. Note that a node within a mesh network can communicate with adjacent nodes. The communication can occur in a cardinal direction from the node or in another direction, such as a diagonal direction, from the node. The first QoS agent receives a request by a primary device within the first node. The request can include a data request. The primary device within the first node requests to send data to a secondary device in a second node within the plurality of nodes. The second node is non-adjacent to the first node, so one or more intermediate nodes will need to be identified to support the sending of data. The first QoS agent analyzes the network traffic data. The analysis can identify network utilization, network latencies, packet errors, resend rates, etc. A first routing agent within the first node selects an intermediate node within the plurality of nodes. The intermediate node is in a route or path between the first node and the second node. More than one intermediate node can be required to complete the route between the first node and the second node. One intermediate node will be adjacent to the second node. The selecting is based on the analyzing. The primary device sends the data to the intermediate node. The intermediate node then transmits the data to the second node if the second node is adjacent to the intermediate node. If not, then one or more additional intermediate nodes are picked to complete the route from the first node to the second node.

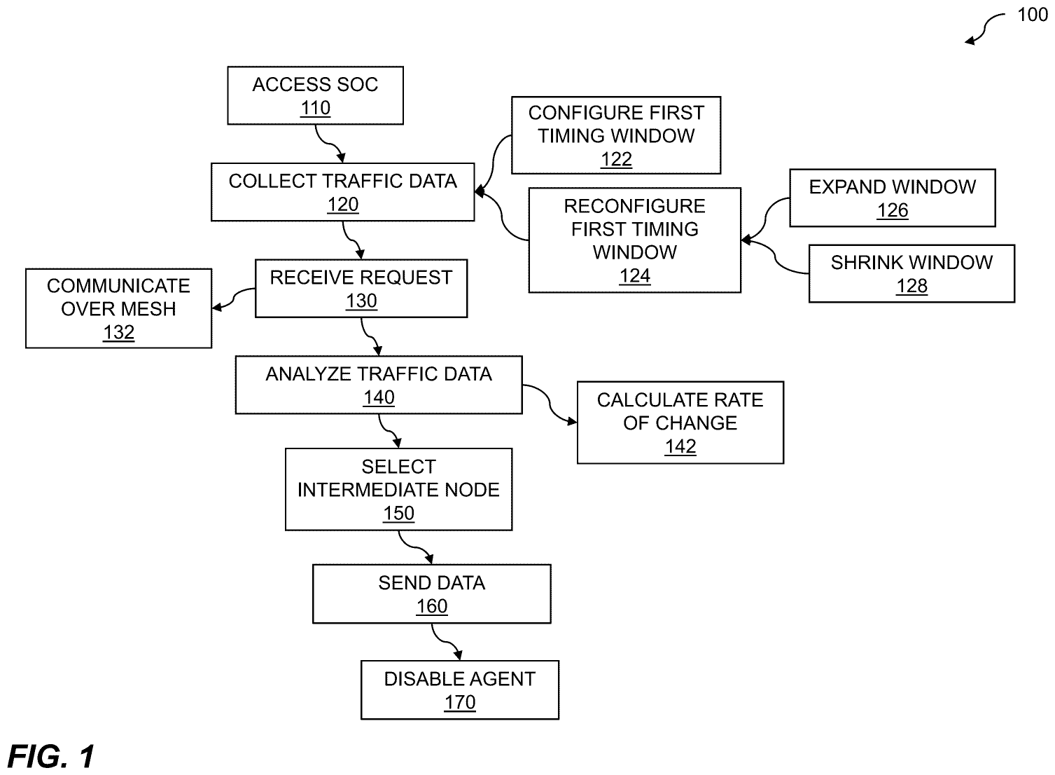

FIG. 1 is a flow diagram for adaptive SoC routing with quality-of-service agents. The flow 100 includes accessing 110 a system-on-a-chip (SoC). The SoC can include an integrated circuit, one or more cores such as processor cores within an integrated circuit, cores within an application-specific integrated circuit, cores or modules within a field programmable chip, and so on. The system SoC can comprise a variety of elements such as processing and multiprocessing elements, storage elements such as shared cache and shared system memory, networking elements within the SoC, networking interfaces to off-SoC networks, and so on. In embodiments, the SoC includes a mesh network. The mesh network can include a packet network. The mesh network can provide bidirectional communication between elements within the SoC. The mesh network can include multiple nodes such as nodes connected in a grid. The grid can enable communications between elements such as switching units (discussed below) associated with the mesh network. The switching unit nodes can be coupled to their nearest neighbors within the mesh network. The coupling can include a north-south-east-west coupling configuration. In embodiments, the mesh network comprises a plurality of nodes. In embodiments, at least one node within the plurality of nodes can include a quality-of-service (QoS) agent. Discussed below, the QoS agent can be used to facilitate communications between nodes, including non-adjacent nodes, within the mesh network.

The flow 100 includes collecting network traffic data 120, by a first QoS agent within a first node within the plurality of nodes. The traffic data can indicate network utilization rates, packet throughput, and so on. The traffic data can include a number of packets in the network, collision rates, error rates, latency times, and so on. The network traffic can include global network traffic, traffic encountered by one or more nodes, and the like. In embodiments, the network traffic data is associated with the first node. The first node can include a node within the mesh network that can receive a request for a data transfer between nodes. When an application, process, task, and so on executes on a mesh network, communications between and among nodes within the mesh network can include transferring data, commands, control signals, and so on. Communications that include data transfers are often governed by data dependencies, scheduling requirements, and the like. In embodiments, the network traffic data occurs during a first timing window. The detecting the network traffic data can occur during a first timing window. The first timing window can be configured. In the flow 100, the collecting includes configuring 122, by the first QoS agent, the first timing window. The configuring can include a window start time, a window width or duration, a window stop time, etc. The timing window configured by the first QoS agent need not remain static or fixed. The flow 100 further includes reconfiguring 124, by the first QoS agent, the first timing window. The reconfiguring can include changing the timing window start time, the timing window duration, etc. In embodiments, the reconfiguring can be based on an accumulated latency. The accumulated latency can include a latency determined for sending along a route within the mesh network between a sending node and a receiving node (discussed below). In the flow 100, the reconfiguring can include expanding 126 the first timing window. The expanding the window can enable collection of more network traffic data. The increased amount of traffic data can provide more information on how traffic changes dynamically on the mesh network. In the flow 100, the reconfiguring can include shrinking 128 the first timing window. The shrinking the timing window can reduce the amount of network traffic data collected, place the timing window over a time period of interest, etc.

In embodiments, the SoC can include a second QoS agent within a second node within the plurality of nodes. The second QoS agent can perform various tasks, functions, and so on that are substantially similar to the tasks, functions, and the like carried out by the first QoS agent. The second QoS agent within the second node can collect network traffic data associated with the second node. The second QoS agent can collect network data in order to enable communication with the first node. The second QoS agent can operate independently of the first node. The first QoS agent and the second QoS agent can be in communication. The communication between the first QoS agent and the second QoS agent can be conducted over a separate network in order to prevent impacting data transfers between nodes within the mesh network.

The flow 100 includes receiving 130, by the first QoS agent, a request by a primary device within the first node to send data to a secondary device in a second node within the plurality of nodes. The data that can be sent can include processed data, partially processed data, unprocessed data, and so on. The first node and the second node can be in communication with each other. In the flow 100, the first QoS agent and the second QoS agent communicate over a separate packetized mesh interface 132. The data can include data in a variety of datatypes such as raw, character, integer, real, floating point, and so on. The data can include command and control information. In embodiments, the first node and the second node can be non-adjacent within the mesh network. That is, the first node and the second node are separated within the mesh network by at least one intermediate node. More than one intermediate node can be between the first node and the second node. In a multiprocessor system, communication such as sending data between processors is common. The inter-processor communication can be based on an order of operation of tasks, can result from branch decisions, etc. The inter-processor communication can be accomplished using a network to which each node can be coupled. The request by the primary device to the QoS agent can include a request to send data from the first node to an additional node. In embodiments, the intermediate node can include the second node. The additional node can include an intermediate node between the first node and the second node, an additional intermediate node, and the like.

The flow 100 includes analyzing 140, by the first QoS agent, the network traffic data. The analyzing can determine one or more parameters associated with the network, where the parameters can be associated with finding a route within the mesh network between the first node and the second node. The parameters can include an appropriateness factor, where the appropriateness can include a number of intermediate nodes, a delay or latency in using a route, and so on. The parameters can include network utilization, collision rates, error rates, timeouts, and so on. The analyzing can determine whether sufficient network capability is available in order to handle a primary device request to send data from the first node to the second node. The sending data can include sending between nodes on the network of the SoC. The parameters associated with the network can be based on a percentage, a threshold, a lookup table, and the like. In embodiments, the receiving and the analyzing can include a second request. The second request can be generated by the primary device within the first node, an additional device within the first node, a device within a different node, etc. In the flow 100, the analyzing can include calculating a rate of change 142 of data bandwidth over the first timing window. The calculating a rate of change of bandwidth can be useful for predicting network behavior and utilization, estimating available bandwidth for a requested data transfer, etc.

A QoS agent such as the first QoS agent within a first node can receive a request from a primary device within the node. The request can include sending data from the primary device in the first node to a secondary device in a second node. Upon receipt of the request, a routing agent associated with the first node can determine one or more routes between the first node and the second node. The routing agent can be included in a coherency ordering agent (COA) within the first node. The first node and the second node may be adjacent to each other or may be separated by one or more intermediate nodes. In embodiments, the first node and the second node are non-adjacent within the mesh network. When the first node and the second node are non-adjacent, the routing agent can determine one or more paths or routes comprising at least one intermediate node. A degenerate case can exist. For example, the intermediate node can comprise the second node. In this case, no intermediate node is required on a route between the first node and the second node. In other embodiments, the intermediate node can be adjacent to the second node. In a usage example, three nodes are associated with the request to send data from the first node to the second node. The three nodes include the first node, the intermediate node, and the second node. In other embodiments, the intermediate node can be non-adjacent to the second node. In this latter scenario, additional intermediate nodes are required to send data from the first node to the second node. In a usage example, more than three nodes are associated with the request to send data from the first node to the second node. The more than three nodes include the first node, the intermediate node, one or more additional nodes, and the second node.

The flow 100 includes selecting 150, by a first routing agent within the first node, an intermediate node within the plurality of nodes. In embodiments, the selecting is based on the analyzing. The intermediate node that is selected can be any adjacent node to the first node.

This can include a node to the north, south, east, west, diagonal, and so on of the first node.

Edge nodes or corner nodes can select intermediate nodes that are in a cardinal direction to an adjacent node or in a diagonal direction to an adjacent node associated with mesh network. The node in a cardinal direction or a diagonal direction can include an edge node or a node within the mesh network. The selecting can include selecting a “reasonable” route. A reasonable route can include a shortest route that progresses in a cardinal, a diagonal, etc. direction between the first node and the second node. A reasonable route can include a route based on lowest network traffic utilization. A reasonable route can be based on a balance between a shortest route and a lowest network utilization route. In embodiments, the intermediate node is adjacent to the second node. Since the intermediate node that was selected is adjacent to the second node, no additional intermediate nodes are required to enable a route from the intermediate node to the second node. If the intermediate node is non-adjacent to the second node, then at least one additional intermediate node is required to complete a route to the second node.

The flow 100 includes sending 160, by the primary device, the data to the intermediate node. The data that is sent can be packetized and can be routed by the routing agent from the first node to the intermediate node. The sending can be based on a NoC. The routing of the data can be accomplished by the selected route that includes the intermediate node. If the intermediate node is non-adjacent to the second node, then one or more additional intermediate nodes that were picked can complete the route between the first node and the second node. The sending from an intermediate node to an additional intermediate node or to the second node can be accomplished by forwarding. Embodiments can include forwarding the data from the intermediate node to the second node. In embodiments, the sending is based on an estimated latency. The estimated latency can result from analysis of the collected network traffic data. The estimated latency can be associated with sending from the first node to an intermediate node. An estimated latency can be determined for sending from the first node to an intermediate node, for transmitting data between intermediate nodes, for transmitting data from an intermediate node to the second node, etc. The estimated latencies can accumulate along the path or route between the first node and the second node. Additional latencies can be based on the additional collected network traffic data, the one or more intermediate nodes between the first node and the second node, and so on. The sending is completed by the second node receiving the sent data.

In other embodiments, the sending can include an accumulated latency associated with the request. The actual latency that was achieved in fulfilling a request can be dynamic. The dynamic latency that is introduced by sending data to an intermediate node, transferring data between intermediate nodes, and transferring data to the second node can change based on network traffic that is on the mesh network at the time of the sending and transferring. The accumulated latency can be compared to the estimated latency. In a usage example, the accumulated latency associated with the request can be less than the estimated latency, substantially equal to the estimated latency, greater than the estimated latency, etc. The accumulated latency can indicate a potential challenge with sending data from the first node to the second node. The accumulated latency could cause an error or exception associated with the data sent from the first node to the second node. In a usage example, an exception could result from the sent data arriving too late. Embodiments can further include determining, by the intermediate QoS agent, an accumulated latency associated with the request. Further embodiments can include examining, by the intermediate QoS agent, the additional network traffic data. In addition to accumulating latency, an intermediate node can choose an additional intermediate node if the intermediate node is not coupled to the second node. Further embodiments can include picking, by an intermediate routing agent, a second intermediate node within the plurality of nodes. In embodiments, the picking is based on the examining. The picking can further be based on a factor such as a “reasonableness” factor associated with the picking the second intermediate node. The reasonableness can be based on low network traffic, determined latencies, and so on. The reasonableness factor can be based on a circuitous route factor. The reasonableness factor can be based on a predetermined routing algorithm within the COA, such as an XY algorithm (route in the X direction first, then Y to navigate to the second node), a YX algorithm (route in the Y direction first, then X to navigate to the second node), and so on. A high circuitous route factor associated with the route between the first node and the second node can indicate that an alternative, more direct route should be sought. In embodiments, the picking can be based on the accumulated latency.

Further embodiments can include updating the accumulated latency, by one or more additional QoS agents within each of the one or more additional intermediate nodes. The accumulated latency is generated or “accumulated” as intermediate nodes are picked to determine a route or path to enable the request by the primary device within the first node to send data to a secondary device in a second node. Further embodiments can include comparing, by the first QoS agent, the estimated latency to the accumulated latency. The comparison by the first QoS agent can determine a difference between the estimated latency and the accumulated latency. The accumulated latency can differ from the estimated latency based on analysis of additional, collected network traffic data. In a usage example, the accumulated latency is less than the estimated latency. The accumulated latency can indicate that a viable route is possible between the first node and the second node. In a second usage example, the accumulated latency is greater than the estimated latency. If the accumulated latency is less than a threshold, a maximum allowable latency value, etc., then the route can be a viable route for sending the data. If the accumulated latency is above a threshold, then an attempt can be made to find an alternate route.

Further embodiments can include saving a routing history. The routing history can be used to provide a viable route for sending from the first node to the second node, as a starting reference for determining intermediate nodes, and so on. The routing history can be stored in a register file, a table such as a routing, cache such as a local cache or a shared cache, and so on. In embodiments, the routing history includes the estimated latency, the accumulated latency, the first node, the one or more additional intermediate nodes, and the second node. The routing history can provide a record of routes or paths that were successfully found to enable sending of data between nodes within a reasonable timeframe. In embodiments, the receiving and the analyzing can include a second request. The receiving and the analyzing can be associated with a request to send data between nodes that have communicated previously, exchanged a substantially similar amount of data, and the like. In embodiments, the selecting a first intermediate node, one or more additional intermediate nodes, etc. can be based on the routing history. The routing history can be used to successfully send data between a first node and a second node without having to recalculate each node selection based on the previously successfully chosen route.

The flow 100 can further include disabling 170 the first QoS agent. The first QoS agent can be disabled in order to reduce processing requirements associated with the first node, to reduce power consumption and the resultant heat dissipation of the first node, and so on. When the first QoS agent is disabled, the routing from the first node to the second node can be handled solely by the routing agent within the first node. The data can be sent using a short route, a direct route, a random route, etc. The data sent by the routing agent within the first node can arrive at the second node at an unpredictable time. The second node can include a QoS agent which can intelligently route data to another node. The QoS agent within the second node can also be disabled.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

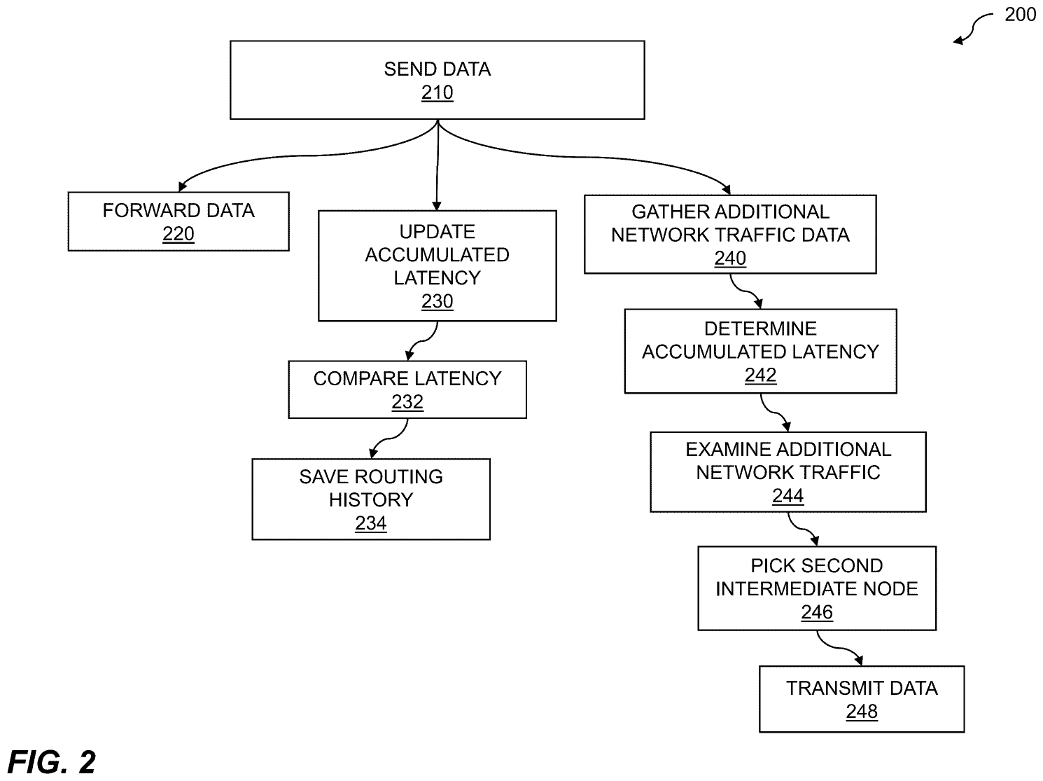

FIG. 2 is a flow diagram for sending data with quality-of-service (QoS) agents. Discussed previously, QoS agents can collect and analyze network traffic data from network connections between nodes within a mesh network. The nodes can communicate with adjacent nodes in the mesh in a diagonal direction; a cardinal direction such as east, west, north, and south; and so on. Edge nodes and corner nodes communicate with the nodes in the mesh network that are adjacent to them. The nodes positioned in adjacent positions from a first node can be executing commands, making their own requests to send data, and so on. As a result, network traffic associated with adjacent nodes from the first node can differ. The sending of the data can be managed by agents such as quality-of-service (QoS) agents. Thus, sending from a primary device within the first node to a secondary device in a different node can experience different latencies. Further, sending latencies can change over time due to changing processing at a node, receiving a request to send or transmit data, and so on. Thus, a path or route used for sending data can be changed. Sending data is enabled using adaptive SoC routing with distributed quality-of-service agents.

A system-on-a-chip (SoC) is accessed. The SoC includes a mesh network. The mesh network comprises a plurality of nodes, where at least one node within the plurality of nodes includes a quality-of-service (QoS) agent. Network traffic data is collected by a first QoS agent within a first node within the plurality of nodes. The network traffic data is associated with the first node. The network traffic data occurs during a first timing window. The first QoS agent receives a request by a primary device within the first node to send data to a secondary device in a second node within the plurality of nodes. The first QoS agent analyzes the network traffic data. A first routing agent within the first node selects an intermediate node within the plurality of nodes. The selecting is based on the analyzing. The primary device sends the data to the intermediate node.

Data is sent between devices via one or more intermediate devices using quality-of-service agents. The data can be sent from a primary device within a first node to a secondary device in a second node. In embodiments, the first node and the second node can be non-adjacent within the mesh network. The nodes can be non-adjacent in a diagonal direction; a cardinal direction such as east, west, north, and south; and so on. Since the nodes are non-adjacent, the one or more intermediate nodes can be used to enable sending from the first node to the second node. The flow 200 includes sending 210, by the primary device, the data to an intermediate node. The data can include a variety of data types such as character data, integer data, real data, etc. The data can include raw data, intermediate result data, final result data, and so on. The data can include processing results from a layer within a network such as a neural network. The intermediate node can be selected by a first routing agent within the first node. The selecting can be based on analyzing collected network traffic data. More than one intermediate node can be required to obtain a route between the first node and the second node. Eventually, an intermediate node can be adjacent to the second node. The flow 200 further includes forwarding the data 220 from the intermediate node to the second node. The intermediate node that forwards the data to the second node can be adjacent to the second node. The intermediate node that sends the data to the second node can have received the data from the first node or another intermediate node.

Recall that selecting an intermediate node through which data is sent from the first node can eventually allow the data to reach the second node. The intermediate node can be coupled to the second node via the mesh network, or can be coupled to one or more additional intermediate nodes. The last intermediate node along the route or path between the first node and the second node is coupled to the second node. In embodiments, the sending is based on an estimated latency. In other embodiments, the sending is based on an accumulated latency. The estimated latency can include the latency between two nodes, and the accumulated latency can include latencies that can be encountered along a route from the first node to the second node. The latencies can be determined by the QoS agent within the first node, and QoS agents within one or more intermediate nodes. The flow 200 further includes updating the accumulated latency 230, by one or more additional QoS agents within each of the one or more additional intermediate nodes. The selection of intermediate nodes can be based on analyzing network traffic data collected within a time window.

The network traffic can change over time, causing the latency for transferring data between nodes to also change. The change in network traffic can result in decisions to select one intermediate node over one or more others. The selection of an intermediate node can be based on latency. The flow 200 can further include comparing 232, by the first QoS agent, the estimated latency to the accumulated latency. As one or more intermediate nodes are selected to enable a route between the first node and the second node, the accumulated latency can increase. The accumulated latency can be compared to the estimated latency in order to determine whether the selected route between the first node and the second node is sufficiently “good” to enable the route to be viable. A good route can be a route with the lowest or at least acceptable latency that enables sending data between the first node and the second node. Once a good route for sending data is found, it can be saved as a possible route for future sending of data. The flow 200 further includes saving a routing history 234. In embodiments, the routing history can include the estimated latency, the accumulated latency, the first node, the one or more additional intermediate nodes, and the second node. The routing history can be stored in a table, local memory, shared memory, system memory, etc.

The flow 200 further includes gathering additional network traffic data 240. The additional traffic can be gathered by one or more nodes within the mesh array. In embodiments, the additional network traffic data is gathered by an intermediate QoS agent within the intermediate node. The QoS agent can gather the additional network traffic data using network interfaces associated with a node. The network interfaces can couple the node to adjacent nodes in a diagonal direction, cardinal direction, and so on. In embodiments, the additional network traffic data is associated with the intermediate node. In further embodiments, the additional network traffic data occurs during a second timing window. The second timing window can have a duration substantially similar to the first timing window, different from the first timing window, and so on. In embodiments, the first timing window and the second timing window are identical. In embodiments, the second timing window overlaps the first timing window.

The flow 200 can further include determining, by the intermediate QoS agent, an accumulated latency 242 associated with the request. The accumulated latency can include latencies associated with the first node and the intermediate nodes, if any, between the first node and the intermediate node. The flow 200 further includes examining 244, by the intermediate QoS agent, the additional network traffic data. The examining can include determining an amount of network traffic based on the network traffic data collected during the second timing window. The flow 200 can further include picking 246, by an intermediate routing agent, a second intermediate node within the plurality of nodes, wherein the picking is based on the examining. The picking the second intermediate node can be accomplished based on availability of a second node, a lowest latency, and the like. The flow 200 can further include transmitting 248, by the intermediate node, the data to the second intermediate node. When more than one intermediate node is picked for a route between the first node and second node, then transmitting can occur between the intermediate node and the second intermediate node; the second node a third intermediate node; and so on, until an intermediate node transmits the data to the second node.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

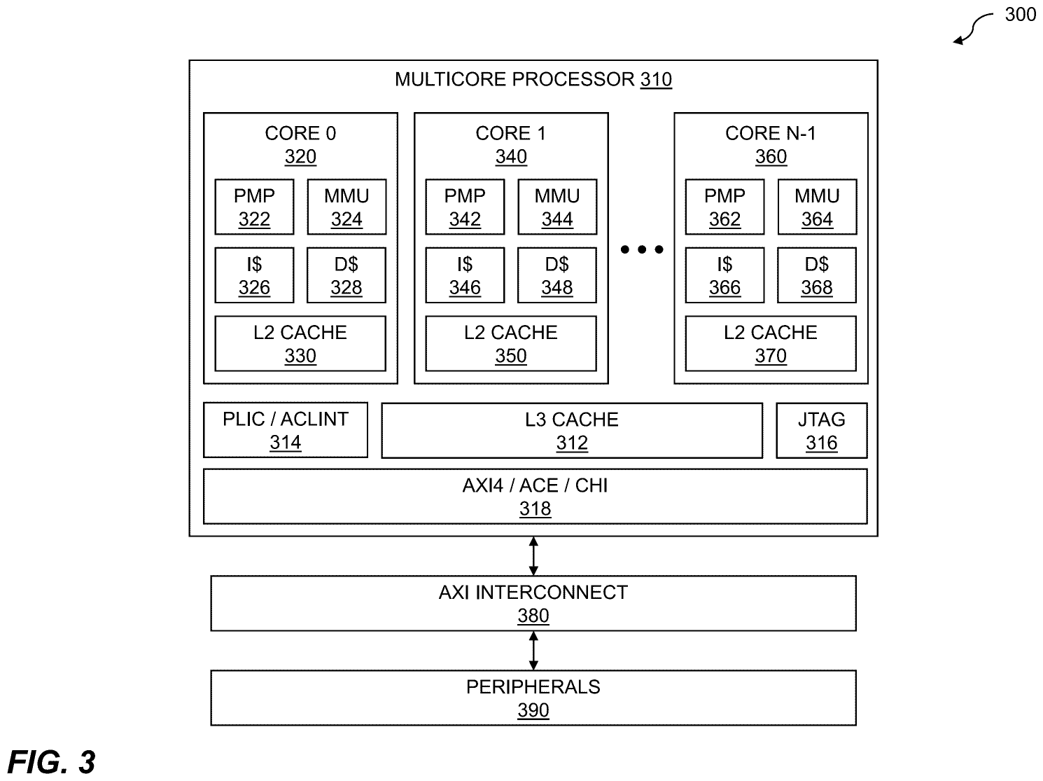

FIG. 3 is a block diagram for a multicore processor. The processor, such as a RISC-V™ processor, ARM processor, or other suitable processor type, can include a variety of elements. The elements can include processor cores including multiprocessor cores, one or more caches, shared memory, memory protection and management units, local storage, and so on. The processor core supports communication within an SoC. The elements of the multicore processor can further include one or more of a private cache; a test interface such as a joint test action group (JTAG) test interface; one or more interfaces to a network such as a network-on-chip, shared memory, and peripherals; and the like. The multicore processor enables adaptive SoC routing with distributed quality-of-service agents. A system-on-a-chip (SoC) is accessed. The SoC includes a mesh network. The mesh network comprises a plurality of nodes, where at least one node within the plurality of nodes includes a quality-of-service (QoS) agent. Network traffic data is collected by a first QoS agent within a first node within the plurality of nodes. The network traffic data is associated with the first node. The network traffic data occurs during a first timing window. The first QoS agent receives a request by a primary device within the first node to send data to a secondary device in a second node within the plurality of nodes. The first QoS agent analyzes the network traffic data. A first routing agent within the first node selects an intermediate node within the plurality of nodes. The selecting is based on the analyzing. The primary device sends the data to the intermediate node.

In the block diagram 300, the multicore processor 310 can comprise two or more processors, where the two or more processors can include homogeneous processors, heterogeneous processors, etc. In the block diagram, the multicore processor can include N processor cores such as core 0 320, core 1 340, core N-1 360, and so on. Each processor can comprise one or more elements. In embodiments, each core, including cores 0 through core N-1 can include a physical memory protection (PMP) element, such as PMP 322 for core 0; PMP 342 for core 1, and PMP 362 for core N-1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 324 for core 0, MMU 344 for core 1, and MMU 364 for core N-1. The memory management units can translate virtual addresses used by software running on the cores to physical memory addresses within caches, the shared memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$ 326 and a data cache D$ 328 associated with core 0; an instruction cache I$ 346 and a data cache D$ 348 associated with core 1; and an instruction cache I$ 366 and a data cache D$ 368 associated with core N-1. In addition to the level 1 instruction and data caches, each core can include a level 2 (L2) cache. The level 2 caches can include L2 cache 330 associated with core 0; L2 cache 350 associated with core 1; and L2 cache 370 associated with core N-1. The cores associated with the multicore processor 310 can include further components or elements. The further elements can include a level 3 (L3) cache 312. The level 3 cache, which can be larger than the level 1 instruction and data caches and the level 2 caches associated with each core, can be shared among all of the cores. The further elements can be shared among the cores. In embodiments, the further elements can include a platform level interrupt controller (PLIC) 314. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interruptor (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces such as an Advanced eXtensible Interface (AXI™) such as AXI4™, an ARM™ Advanced eXtensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In embodiments, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

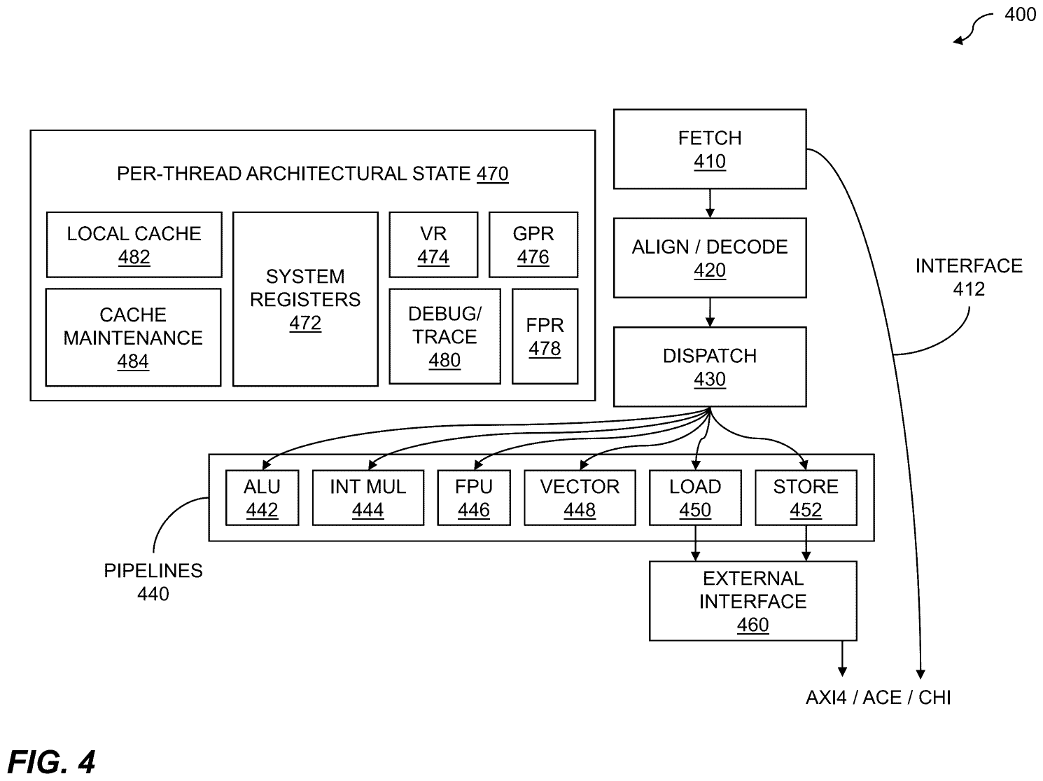

FIG. 4 is a block diagram for a pipeline. One or more pipelines associated with a processor architecture can be used to greatly enhance processing throughput. The processor architecture can be associated with one or more processor cores, multiprocessor cores, and so on. The processing throughput can be increased because multiple operations can be executed in parallel. The processor cores can include cores, nodes, etc. within a system-on-chip (SoC). Data can be sent from a first node to a second node within the SoC by using adaptive SoC routing with distributed quality-of-service (QoS) agents. Embodiments include accessing a system-on-a-chip (SoC). The SoC includes a mesh network, where the mesh network includes a plurality of nodes. At least one node within the plurality of nodes includes a quality-of-service (QoS) agent. Network traffic data is collected by a first QoS agent within a first node within the plurality of nodes. The network traffic data is associated with the first node, and the network traffic data occurs during a first timing window. The first QoS agent receives a request by a primary device within the first node to send data to a secondary device in a second node within the plurality of nodes. The first QoS agent analyzes the network traffic data. A first routing agent with the first node selects an intermediate node within the plurality of nodes. The selecting is based on the analyzing. The primary device sends the data to the intermediate node.

The blocks within the block diagram can be configurable in order to provide varying processing levels. The varying processing levels can be based on processing speed, bit lengths, numbers of micro-operations, and so on. The block diagram 400 can include a fetch block 410. The fetch block 410 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced eXtensible Interface (AXI™), an ARM™ Advanced eXtensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 400 can include a dispatch block 430. The dispatch block can receive decoded instruction packets from the align and decode block. The decoded instruction packets can be used to control a pipeline 440, where the pipeline can include an in-order pipeline, an out-of-order (OoO) pipeline, etc. In embodiments, the processor core executes one or more instructions out of order. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450 and store pipelines 452. The load pipelines and the store pipelines can access storage such as the common memory using an external interface 460. The external interface can be based on one or more interface standards such as the Advanced eXtensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 470. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VR) 474. The vector registers can be grouped in a vector register file and can be used for vector operations. Additional registers such as general-purpose registers (GPR) 476 and floating-point registers (FPR) 478 can be included. These registers can be used for general purpose (e.g., integer) operations and floating-point operations, respectively. The per-thread architectural state can include a debug and trace block 480. The debug and trace block can enable debug and trace operations to support code development, troubleshooting, and so on. In embodiments, an external debugger can communicate with a processor through a debugging interface such as a joint test action group (JTAG) interface. The per-thread architectural state can include a local cache state 482. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, maintenance complete, etc.

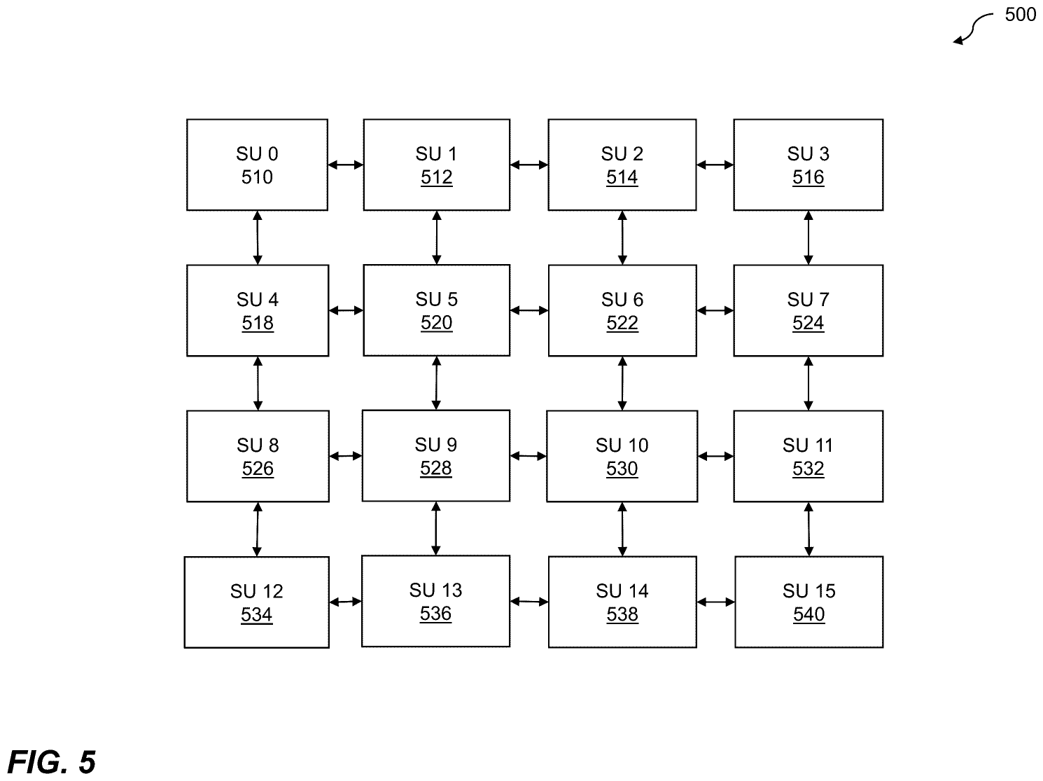

FIG. 5 is an example mesh network with switching units. Discussed previously and throughout, a quality-of-service (QoS) agent can receive a request by a primary device within a first node to send data to a secondary device in a second node within a plurality of nodes. The sending the data can be accomplished by packetizing the data. Packetizing the data can include partitioning the data into parts, forming packets by adding information such as header information, and then sending the packets over a network. The packets can be sent individually and can be sent from a source to a target or destination using one or more routes between the source and the destination. The routes can be chosen based on an individual packet, on network traffic at the time a packet is sent, etc. The packets are then reassembled at the destination. The QoS agent can be associated with a switching unit (SU) within the mesh network. A switching unit may have a QoS agent, more than one QoS agent, and so on. The QoS agents associated with switching units within the mesh network enable adaptive system-on-chip (SoC) routing. A system-on-a-chip (SoC) is accessed. The SoC includes a mesh network. The mesh network comprises a plurality of nodes, where at least one node within the plurality of nodes includes a quality-of-service (QoS) agent. Network traffic data is collected by a first QoS agent within a first node within the plurality of nodes. The network traffic data is associated with the first node. The network traffic data occurs during a first timing window. The first QoS agent receives a request by a primary device within the first node to send data to a secondary device in a second node within the plurality of nodes. The first QoS agent analyzes the network traffic data. A first routing agent within the first node selects an intermediate node within the plurality of nodes. The selecting is based on the analyzing. The primary device sends the data to the intermediate node.

Switching units can be configured in an M×N mesh topology. The example 500 shows an example 4×4 mesh. The switching units within the mesh can include switching units SU 0 510, SU 1 512, SU 2 514, SU 3 516, SU 4 518, SU 5 520, SU 6 522, SU 7 524, SU 8 526, SU 9 528, SU 10 530, SU 11 532, SU 12 534, SU 13 536, SU 14 538, and SU 15 540. In embodiments, a node at each point of the M×N mesh topology can include a switching unit (SU). A switching unit, which can also be referred to as a mesh switch unit, can include one or more of a memory controller interface (MCI), an input/output (I/O) mesh interface (IMI), and so on. In embodiments, at least one node within the plurality of nodes can include a quality-of-service (QoS) agent. Data can be sent across the mesh from a first node within the mesh to a second node within the mesh. The QoS agent can select an intermediate node within the plurality of nodes, where the intermediate node is on a route between a primary device within the first node and a secondary device in the second node within the plurality of nodes. The intermediate node can be selected based on analysis of network traffic data collected by a QoS agent. Each switching unit can include a plurality of ports. The ports can include local ports, directional ports, and the like. The ports can be used for communication with other switching units within the mesh. Each switching unit can be in communication with nearest-neighbor SUs within the matrix. The nearest neighbor SUs within the mesh topology can be in a diagonal direction, one or more cardinal directions, and so on. The cardinal directions can include north, south, east, and west directions. Communication with a nearest neighbor SU can be based on diagonal direction priority, a cardinal direction priority, a combination of priorities, and so on. In embodiments, the cardinal direction priority can be east/west, then north/south. Noted above, the communication with nearest-neighbor SUs can be accomplished using a network-on-chip (NOC). The network-on-chip can be based on techniques including router-based packet switching.

Nodes with the M×N mesh can communicate using a network within a system-on-chip (SoC). Data sent between nodes can be enabled by using distributed QoS agents. At least one node within the mesh can have a QoS agent. The node can have more than one QoS agent. Other nodes within the mesh can have no QoS agents, one QoS agent, or more than one QoS agent. The communication between switching units is based on using a QoS agent within a first node to collect network traffic data. The network traffic data can include an amount of network utilization, data send error rates, data send retry rates, and so on. In embodiments, the network traffic data that is collected occurs during a first timing window. Upon receiving a data send request by a primary device within the first node, the QoS agent can analyze the network traffic data. The traffic analysis by the QoS agent can enable a routing agent within the first node to select an intermediate node. The intermediate node can include a node along a route between the first node that is sending data to the second node which is receiving the data. The communicating between nodes is further based on selecting an adjacent switching unit that is located in a diagonal direction, a cardinal direction, etc. in relation to the first SU. The cardinal direction can include north, south, east, or west. The diagonal direction can include northeast, southeast, southwest, northwest, and so on. More than one route can exist between the first node and the second node. Further, more than one intermediate node can be required to transmit data from intermediate node to intermediate node until an intermediate node is found that is adjacent to the second node and can transmit the sent data to the second node.

In embodiments, the sending can be based on an estimated latency. The estimated latency can include an estimated amount of time that will transpire while sending data from a node such as the first node to another node such as an intermediate node. The estimated latency can be determined from the collected network traffic data. In other embodiments, the sending can include an accumulated latency associated with the request. The accumulated latency can include amounts of time associated with transmitting data from intermediate node to intermediate node, until finally reaching the second node. The data can be forwarded from intermediate node to intermediate node until finally reaching the second node. In embodiments, picking additional intermediate nodes can be based on the accumulated latency. In a usage example, an intermediate routing agent within an intermediate node is attempting to select a next intermediate node in order to continue sending data from the first node to the second node. Estimated latencies can be determined for each intermediate node that might be chosen to send data along a route to the second node. A lower latency pick can reduce any sending delay between the first node and the second node. The pick of an intermediate node that can introduce lower latency can help ensure that data from the first node arrives at the second node in time to be used by the second node.

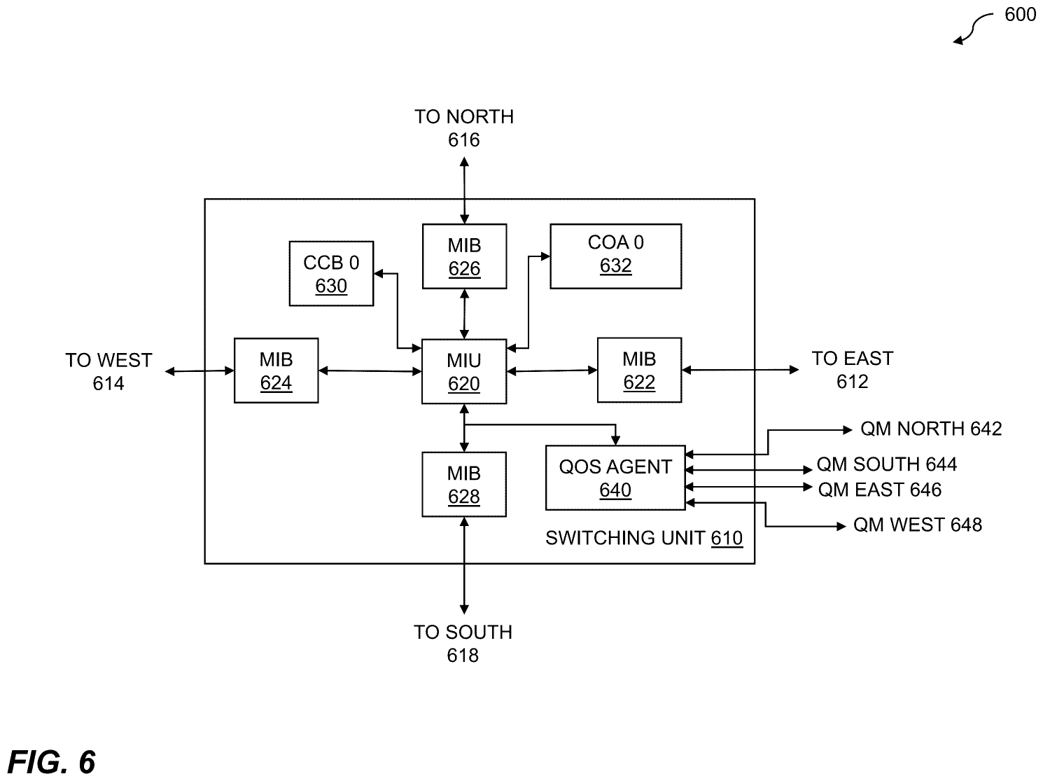

FIG. 6 is a block diagram of a switching unit (SU). Discussed previously and throughout, a plurality of switching units can be configured in an M×N topology such as an M×N mesh topology. The switching units can include one or more of a memory controller interface, an I/O mesh interface, and so on. An SU, or tile, can further include elements for managing communication across the M×N topology. The various elements of a switching unit support adaptive SoC routing with distributed quality-of-service agents. A system-on-a-chip (SoC) is accessed. The SoC includes a mesh network. The mesh network comprises a plurality of nodes, where at least one node within the plurality of nodes includes a quality-of-service (QoS) agent. Network traffic data is collected by a first QoS agent within a first node within the plurality of nodes. The network traffic data is associated with the first node. The network traffic data occurs during a first timing window. The first QoS agent receives a request by a primary device within the first node to send data to a secondary device in a second node within the plurality of nodes. The first QoS agent analyzes the network traffic data. A first routing agent within the first node selects an intermediate node within the plurality of nodes. The selecting is based on the analyzing. The primary device sends the data to the intermediate node.

A network in a mesh topology that comprises M×N elements is described above. The M×N elements, which can be referred to generically as tiles or nodes associated with the mesh topology, can include various elements. The included elements can be based on a variety of node configurations that can perform a variety of operations. The nodes have been described as switching units (SUs), where the switching units can communicate with their nearest neighbor SUs. The nearest neighbor SUs can be located in a diagonal direction from each SU (e.g., northeast, southeast, southwest, and northwest), can be located in cardinal directions from each SU (e.g., north, south, east, and west), and so on. A given SU can be configured to perform one or more operations. Each SU can include one or more elements. An SU can be configured as a coherent mesh unit (CMU), a memory controller interface (MCI), an input/output (I/O) mesh interface (IMI), and so on. A block diagram 600 of a switching unit is shown. The SU can be configured to enable coherency management. In embodiments, the SU is configured to enable adaptive SoC routing with distributed quality-of-service agents. The switching unit 610 can communicate with nearest neighbor SUs that are located in diagonal, cardinal, etc. directions from the SU. A nearest neighbor SU can include an intermediate node, where the intermediate node can assist in sending data between a first node and a second node within the mesh network. The nearest neighbor communications can include diagonal directions and cardinal directions to the east 612, to the west 614, to the north 616, and to the south 618. For some routing situations, the cardinal directions can be prioritized. In a usage example, the cardinal direction priority can be east/west, then north/south.

The switching unit can include a mesh interface unit (MIU) 620. In embodiments, the MIU can initiate adaptive SoC routing. The routing can be accomplished with distributed quality-of-service agents. The SoC routing operation can be associated with a data sending operation. The data sending operation can include a memory access operation such as a read (load), write (store), read-modify-write, and so on. The MIU can generate a request by a primary device within a first node to send data to a secondary device in a second node within the plurality of nodes. The secondary device can be accessible by the first device via one or more intermediate nodes within the plurality of nodes. The MIU can communicate with other MIUs associated with further switching units using one or more interfaces. The switching unit can include one or more mesh interface blocks (MIBs). The MIBs can enable communication between the SU and other SUs within the mesh. The other SUs can be located in cardinal directions from the SU 610. The SU shown can include four MIBs such as MIB 622, MIB 624, MIB 626, and MIB 628. MIB 622 enables communication to the east, MIB 624 enables communication to the west, MIB 626 enables communication to the north, and MIB 628 enables communication to the south. The other SUs can also be located in diagonal directions from the SU 610.

The switching unit comprises a node within a plurality of nodes within a system-on-a-chip (SoC). The node can enable adaptive SoC routing within the M×N mesh. The node can further include a cache coherency block (CCB). The cache coherency block can include processors such as processor cores, local cache memory, shared cache memory, intermediate memories, and so on. In embodiments, the node includes a cache coherency block (CCB) such as CCB 0 630 and a coherency ordering agent (COA) such as a COA 0 632. The COA can comprise a routing agent. The routing agent can include a route including an intermediate node, where the intermediate node is located along a route or path between the first node and the second node. The routing agent can implement an XY (horizontal then vertical) algorithm, a YX (vertical then horizontal) algorithm, and so on. The routing agent can be used to pick a further intermediate node. The picking of the further intermediate node can be altered by the QoS agent. The picking of the further intermediate node can be based on examining network traffic data. The CCB can include a “block” of storage, where the block can include one or more of shared local cache, shared intermediate cache, and so on. The CCB can maintain coherency among cores such as processor cores, tiles, switching units, etc. The COA can be used to control coherency with other elements outside of the M×N mesh. The CCB and the COA can be included in one or more switching units within the M×N mesh. In embodiments, the adjacent coherent node can include a CCB and a COA. The adjacent block CCB and COA can be used to maintain memory coherency within the adjacent coherent tile. In embodiments, the adjacent coherent tile can include one or more memory control interfaces (MCIs). The COA or routing agent can be used to route data between the first node that is sending the data and the second node that is receiving the data.

The switching unit can include a quality-of-service (QoS) agent 640. In embodiments, at least one node within the plurality of nodes includes a QoS agent. A node can include more than one QoS agent. The QoS agent can perform a plurality of tasks within a switching unit. In embodiments, a first QoS agent can collect network traffic data. The network traffic data can be collected during a first timing window. The network traffic that is collected can be associated with the first node. In embodiments, the first QoS agent can receive a request by a primary device within the first node. The request can include a data request such as a request to send data. In embodiments, the request comprises sending data to a secondary device in a second node within the plurality of nodes. The data can include raw data, partially processed data, processed data, and so on. The data can be sent to the second node for further processing. In embodiments, the first QoS agent can analyze the network traffic data. The analysis can include examining network utilization, data such as packet data send success rates, send failure rates, send retry rates, and the like. In further embodiments, a first routing agent within the first node selects an intermediate node within the plurality of nodes, where the selecting is based on the analyzing. Recall that sending data between nodes that are adjacent can be the degenerate case, where the two nodes communicate directly. In other cases where data is sent from a first node to a second node, the nodes are non-adjacent. As a result, one or more intermediate nodes must be picked in order to enable a route or path from the first node to the second node. Thus, a routing agent within the node can select an intermediate node based on the analyzing.

In the switching unit, the QoS agent can be in communication with one or more additional QoS agents. The additional QoS agents can include QoS agents within other switching units. In embodiments, the SoC can include a second QoS agent within a second node within the plurality of nodes. The communication between QoS agents can include sharing latency information. In embodiments, the first QoS agent and the second QoS agent can communicate over a separate packetized mesh interface. The communications between QoS agents can occur in the cardinal directions discussed previously. In the switching unit 610, the QoS agent-to-agent communication can occur through one or more QoS mesh interfaces (QM) such as QM north 642, QM south 644, QM east 646, and QM west 648. The latency information can be used for controlling the sending of data from the first node to the second node. In embodiments, the sending can be based on an estimated latency. The estimated latency can be associated with data sent between nodes based on the collected network traffic data. As the QoS agents within intermediate nodes pick further intermediate nodes to determine a route or path between the first node and the second node, an accumulated latency can be determined. In embodiments, the sending includes an accumulated latency associated with the request. The estimated latency and the accumulated latency can be used to determine whether a proposed route between the first node and the second node is viable. In a first usage example, the accumulated latency can be too long which would cause data to arrive too late to prevent stalling of the M×N mesh. In a second usage example, the accumulated latency can be used to determine that too many intermediate nodes are associated with a possible route. Thus, an alternative route that utilizes fewer intermediate nodes can be sought.

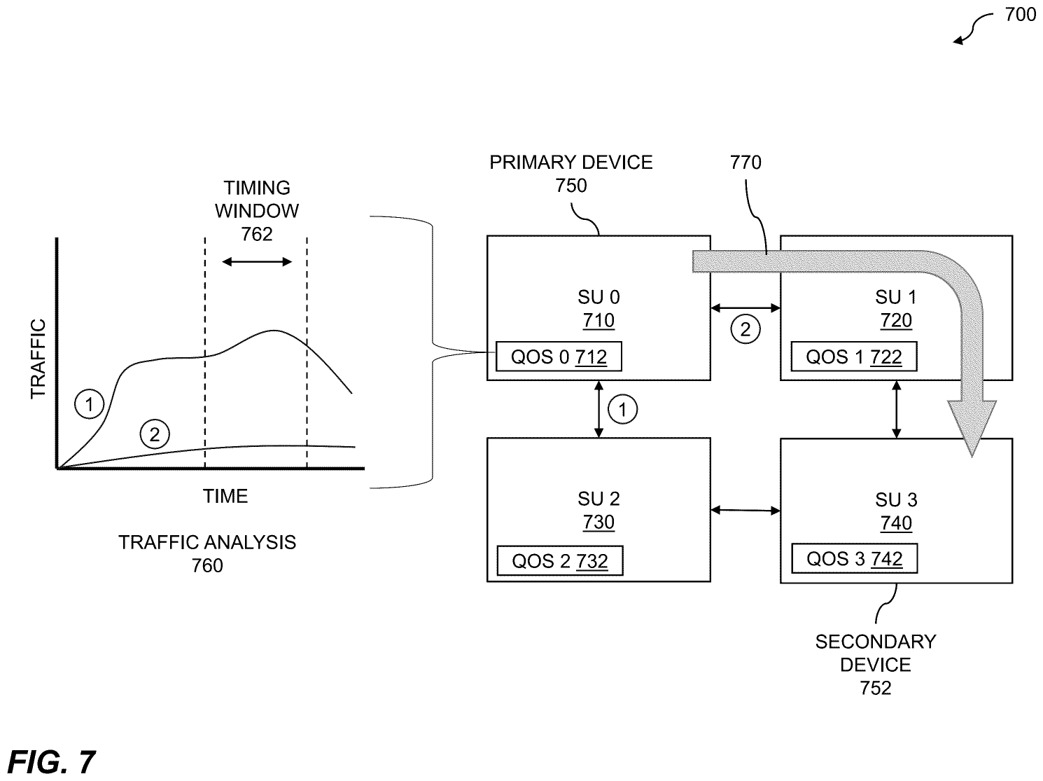

FIG. 7 is an example of sending data from a primary device to a secondary device. Discussed previously and throughout, a QoS agent can receive a request from a primary device within a node to send data to a secondary device within a second node. The QoS agent can analyze collected network traffic to select a first intermediate node, where the first intermediate node is on a route between the first node and the second node. The network traffic data can be collected within a timing window. Additional network traffic data can be collected, where the additional network traffic can be collected for a second route between the first node and a second intermediate node. By analyzing the two sets of collected network traffic data, an intermediate node, such as the intermediate node that can be accessed with lower latency, can be selected. The sending data between devices is enabled by adaptive SoC routing with distributed quality-of-service agents. A system-on-a-chip (SoC) is accessed. The SoC includes a mesh network. The mesh network comprises a plurality of nodes, where at least one node within the plurality of nodes includes a quality-of-service (QoS) agent. Network traffic data is collected by a first QoS agent within a first node within the plurality of nodes. The network traffic data is associated with the first node. The network traffic data occurs during a first timing window. The first QoS agent receives a request by a primary device within the first node to send data to a secondary device in a second node within the plurality of nodes. The first QoS agent analyzes the network traffic data. A first routing agent within the first node selects an intermediate node within the plurality of nodes. The selecting is based on the analyzing. The primary device sends the data to the intermediate node.

The example 700 shows an example of sending data from a primary device to a secondary device. The sending is enabled by adaptive SoC routing with distributed quality-of-service agents. Recall that a system-on-a-chip (SoC) is accessed. The SoC includes a mesh network comprising a plurality of nodes. The nodes can be configured as switching units (SUs), where switching units can communicate with other switching units within the mesh network. In the figure, the nodes within the mesh network can include SU 0 710, SU 1 720, SU 2 730, and SU 3 740. While four switching units are shown, the mesh network can include other numbers of SUs. In embodiments, at least one node within the plurality of nodes includes a quality-of-service (QoS) agent. The mesh network can include more than one QoS agent, such as QoS agent 0 712 associated with SU 0; QoS agent 1 722 associated with SU 1; QoS agent 2 732 associated with SU 2; and QoS agent 3 742 associated with SU 3.

In embodiments, the first QoS agent receives a request by a primary device 750 within the first node to send data to a secondary device 752 in a second node within the plurality of nodes. The primary device and the secondary device can include non-adjacent SU devices; this indicates that direct communication between the primary device and the secondary device is not supported within the mesh network. Since communication is supported in cardinal directions north, south, east, and west, at least one intermediate node will be required to enable the sending of data by the primary device to the secondary device in the example 700. In embodiments, network traffic is collected by the first QoS agent within a first node. The network traffic data can include an amount of traffic such as a number of packets on the network, packet error rates, packet retry rates, and so on. The network traffic data can be collected for network connections in each of the cardinal directions. In the figure, QoS agent 0 within SU 0 can collect network traffic between SU 0 and SU 2 indicated by path 1; and QoS agent 0 can further collect network traffic data between SU 0 and SU 1, indicated by path 2. In embodiments, the first QoS agent can analyze the network traffic data 760. The traffic analysis can include analyzing an amount of traffic such as packet traffic that occurs on path 1 during an amount of time. The amount of time can include a timing window 762 such as a first timing window. The traffic analysis can further include analyzing the amount of traffic that occurs on path 2 during the timing window. The amount of traffic on the two paths can be plotted and compared. In the graph, path 2 shows much lower traffic in comparison to path 1.

Based on the analysis by the first QoS agent, a first routing agent within the first node can select an intermediate node on a path between first node and the second node. Since the network traffic is lower on path two, the first routing agent can select switching unit SU 1 as the first intermediate node. In embodiments, the intermediate node can be adjacent to the second node. In the figure, intermediate node SU 1 is adjacent to the second node SU 3. The intermediate node can be used to send data from the primary device, by the intermediate node, to the secondary device. The path along which the sending is accomplished is shown at 770. In embodiments, the sending can be based on an estimated latency. The estimated latency can be based on the collected network traffic data, the amount of data to be sent from the primary device, and so on. In further embodiments, the sending can include an accumulated latency. The accumulated latency can include one or more latencies associated with one or more intermediate nodes, a latency between the intermediate node adjacent to the second node, etc. The accumulated latency is associated with the request.

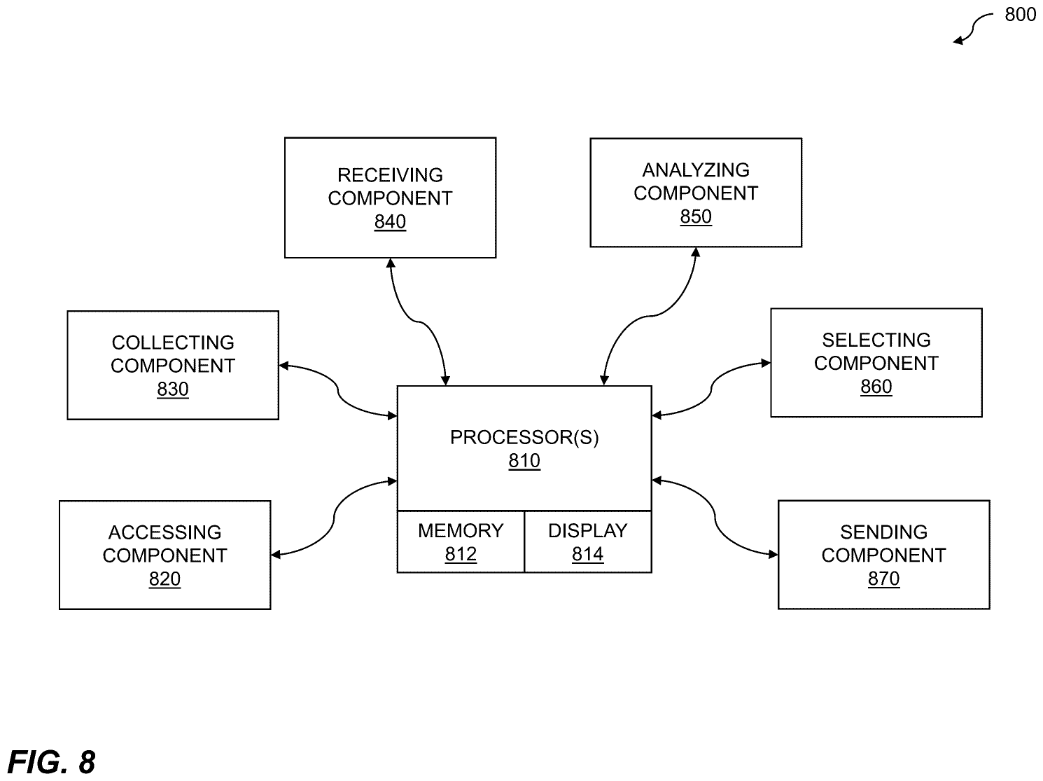

FIG. 8 is a system diagram for adaptive SoC routing of quality-of-service agents. The system can comprise a computer system for communication. The computer system can be based on semiconductor logic. The system can include one or more of processors, memories, cache memories, queues, displays, communications channels and networks, and so on. The system 800 can include one or more processors 810. The processors can include standalone processors within integrated circuits or chips, processor cores in FPGAs or ASICs, two or more processor cores within a multiprocessor, and the like. The one or more processors 810 are coupled to a memory 812, which stores instructions, operations, network traffic data, data requests, estimated latencies, accumulated latencies, routing information, and so on. The memory can include one or more of local memory, shared cache memory, shared hierarchical cache memory, system memory such as shared system memory, etc. The system 800 can further include a display 814 coupled to the one or more processors. The display can be used for displaying data, instructions, operations, memory queue contents, various types of latencies, routing information, etc. The operations can route operations, data transfer operations, and so on. The operations can further include cache maintenance operations, Advanced eXtensible Interface (AXI™) Coherence Extensions (ACE™) cache transactions, Advanced Microcontroller Bus Architecture (AMBA™) Coherence Hub Interface (CHI™) transactions, etc.

A system comprising the one or more processors, when executing the instructions which are stored in the memory, is configured to: access a system-on-a-chip (SoC), wherein the SoC includes a mesh network, wherein the mesh network comprises a plurality of nodes, wherein at least one node within the plurality of nodes includes a quality-of-service (QoS) agent; collect network traffic data, by a first QoS agent within a first node within the plurality of nodes, wherein the network traffic data is associated with the first node, and wherein the network traffic data occurs during a first timing window; receive, by the first QoS agent, a request by a primary device within the first node to send data to a secondary device in a second node within the plurality of nodes; analyze, by the first QoS agent, the network traffic data; select, by a first routing agent within the first node, an intermediate node within the plurality of nodes, wherein the selecting is based on the analyzing; and send, by the primary device, the data to the intermediate node.

The system 800 can include an accessing component 820. The accessing component can include functions and instructions for accessing a system-on-a-chip (SoC). The SoC can include an integrated circuit, one or more cores within an integrated circuit, cores within an application-specific integrated circuit, modules within a field programmable chip, and so on. The SoC can include a variety of elements, where the elements can include one or more processors; storage elements such as local cache memory, shared cache memory, hierarchical cache memory, and a memory system; network interfaces, where the network interfaces can enable access to channels, buses, and networks; and the like. The SoC can include further elements depending on the usage of the SoCs. In a usage example, an SoC can further include analog, mixed-signal, and radio frequency (RF) elements. In embodiments, the SoC can include a mesh network. The mesh network can include multiple nodes such as nodes connected in a grid. The grid can enable communications between switching unit elements associated with the mesh network. The switching units can be coupled to their nearest neighbors. The coupling can include a north-south-east-west coupling configuration. In embodiments, the mesh network comprises a plurality of nodes. At least one node within the plurality of nodes can include a quality-of-service (QoS) agent. Discussed below, the QoS agent can be used to facilitate communications between nodes, including non-adjacent nodes, within the mesh network.

A processor such as a processor core within the SoC can include an ARM core, a MIPS core, and/or other suitable core type. In embodiments, the processor core can include a RISC-V architecture. The processor core can include a processor core within a plurality of processor cores. The processor core supports atomic memory operations. The RISC-V architecture can include extensions, where the extensions can enable execution of various arithmetic and logic operations. In embodiments, RISC-V architecture can include extensions that enable the adaptive routing with distributed quality-of-service agents.

The system 800 can include a collecting component 830. The collecting component can include functions and instructions for collecting network traffic data. The network traffic data can include data collected at a point in time, data collected over a period of time, and so on. The network traffic data can include an amount of data in bytes, words, or other data measurements. The network traffic data can include a number of packets such as network packets. A number of network packets collected at a point in time or over a period of time can indicate a load on the network. In embodiments, the network traffic data is collected by a first QoS agent within a first node within the plurality of nodes. The first QoS agent can determine the collected network traffic data to determine a state or condition of the network. The determining can be based on analysis (discussed below). Since the network from which the data network traffic data is collected is coupled to each node within the mesh network, different nodes can observe differing traffic data. In embodiments, the network traffic data is associated with the first node. Further, not only can the network traffic vary depending on which node collects the data, the network traffic data can vary over time. In embodiments, the network traffic data occurs during a first timing window. The first timing window can be used to sample network traffic data for channel availability. The first timing window can be configured. The configuring can include a window start time, a window width, etc. Further embodiments can include gathering additional network traffic data. The additional traffic data can be gathered by an intermediate QoS agent within an intermediate node. The additional network traffic data is associated with the intermediate node, wherein the additional network traffic data occurs during a second timing window. Discussed below, the intermediate node can include a node between the first node and a second or target node. In embodiments, the first timing window and the second timing window can be identical. The first node and the intermediate node can see different network traffic data at a same given time. The first window and the second window can be used to determine whether sufficient network capability is available for communication between the first node and the intermediate node.

The system 800 can include a receiving component 840. The receiving component can include functions and instructions for receiving, by the first QoS agent, a request by a primary device within the first node to send data to a secondary device in a second node within the plurality of nodes. The data that can be sent can include processed data, partially processed data, unprocessed data, and so on. The data can include command and control information. In embodiments, the first node and the second node can be non-adjacent within the mesh network. In a multiprocessor system, communication such as sending data between processors is common. The inter-processor communication can be based on an order of operation of tasks, can result from branch decisions, etc. The inter-processor communication can be accomplished using a network to which each node can be coupled. The request by the primary device to the QoS agent can include a request to send data from the first node to an additional node. The additional node can include a second node, an intermediate node between the first node and the second node, an additional intermediate node, and the like.

The system 800 can include an analyzing component 850. The analyzing component can analyze, by the first QoS agent, the network traffic data. The analyzing can determine one or more parameters associated with the network. The parameters can include network utilization, collision rates, error rates, timeouts, and so on. The analyzing can determine whether sufficient network capability is available in order to handle a primary device request to send data. The sending data can include sending between nodes on the network of the SoC. The parameters associated with the network can be based on a percentage, a threshold, a lookup table, and the like.

When a QoS agent such as the first QoS agent within a first node receives a request from a primary device within the node to send data from the first node to a second node, a routing agent associated with the node can determine one or more routes between the first node and the second node. The nodes may be adjacent to each other or may be separated by one or more intermediate nodes. When the first node and the second node are nonadjacent, the routing agent must determine one or more paths or routes comprising at least one intermediate node. In embodiments, the intermediate node can be adjacent to the second node. In a usage example, three nodes are associated with the request to send data from the first node to the second node.

The three nodes include the first node, the intermediate node, and the second node. In other embodiments, the intermediate node can be non-adjacent to the second node. In this latter scenario, additional intermediate nodes are required to send data from the first node to the second node. In a usage example, more than three nodes are associated with the request to send data from the first node to the second node. The more than three nodes include the first node, the intermediate node, one or more additional nodes, and the second node.

The system 800 can include a selecting component 860. The selecting component can include functions and instructions for selecting, by a first routing agent within the first node, an intermediate node within the plurality of nodes. The selecting is based on the analyzing. The intermediate node that is selected can be a node to the north, south, east, or west of the first node. Edge nodes or corner nodes can only select routes along an edge of the mesh or into the mesh. The selecting can include selecting a “reasonable” route. A reasonable route can include a shortest route between the first node and the second node, a route based on lowest network traffic utilization, and so on. A reasonable route can be based on a balance between a shortest route and a lowest network utilization route.

The system 800 can include sending component 870. The sending component can include functions and instructions for sending, by the primary device, the data to the intermediate node. The data can be packetized and can be routed by the routing agent from the first node to the intermediate node. When the second node is non-adjacent to the intermediate node, the sending can include sending to one or more additional node before sending to the second node. The sending from an intermediate node to an additional intermediate node or to the second node can be accomplished by forwarding. Embodiments can include forwarding the data from the intermediate node to the second node. In embodiments, the sending is based on an estimated latency. The estimated latency can be based on the collected network traffic data. The estimated latency can be associated with sending from the first node to an intermediate node. In other embodiments, the sending can include an accumulated latency associated with the request. An estimated latency can be determined for sending from the first node to an intermediate node, for transmitting data between intermediate nodes, for transmitting data from an intermediate node to the second node, etc.

The estimated latencies can accumulate along the path or route between the first node and the second node. The additional latencies can be based on the additional collected network traffic data, a number of intermediate nodes between the first node and the second node, and so on. The latency associated with a request is dynamic in that the latency introduced by sending data to an intermediate node, transferring data between intermediate nodes, and transferring data to the second node can change based on network traffic at the time of the sending and transferring. In a usage example, the accumulated latency associated with the request can be less than the estimated latency, substantially equal to the estimated latency, greater than the estimated latency, etc. An accumulated latency could cause an error or exception associated with the data sent from the first node to the second node. In a usage example, an exception could include the sent data arriving too late. Embodiments can further include determining, by the intermediate QoS agent, an accumulated latency associated with the request. The latency associated with an intermediate node can be determined by an intermediate QoS agent. Further embodiments can include examining, by the intermediate QoS agent, the additional network traffic data. In addition to accumulating latency, an intermediate node can choose an additional intermediate node if the intermediate node is not coupled to the second node. Further embodiments can include picking, by an intermediate routing agent, a second intermediate node within the plurality of nodes, wherein the picking is based on the examining. The picking can further be based on a factor such as a “reasonableness” factor associated with the picking the second intermediate node. The reasonableness can be based on low network traffic, determined latencies, and so on. In embodiments, the picking can be based on the accumulated latency.

Further embodiments can include updating the accumulated latency, by one or more additional QoS agents within each of the one or more additional intermediate nodes. The accumulated latency forms as intermediate nodes are picked to determine a route or path to enable the request by the primary device within the first node to send data to a secondary device in a second node. Further embodiments can include comparing, by the first QoS agent, the estimated latency to the accumulated latency. The comparison can determine a difference between the estimated latency and the accumulated latency. The accumulated latency can differ from the estimated latency. In a usage example, the accumulated latency is less than the estimated latency. The accumulated latency can indicate that a viable route is possible between the first node and the second node. In a second usage example, the accumulated latency is greater than the estimated latency. If the accumulated latency is less than a threshold, a maximum allowable latency value, etc., then the route can be a viable route for sending the data. If the accumulated latency is above a threshold, then an attempt can be made to find an alternate route, or the sending can fail. A sending failure can result in an exception.

Further embodiments can include saving a routing history. The routing history can be stored in a cache, a table, a register file, and so on. The routing history can include the estimated latency, the accumulated latency, the first node, the one or more additional intermediate nodes, and the second node. The routing history can provide a record of routes or paths that were successfully found to enable sending of data between nodes within a reasonable timeframe. In embodiments, the receiving and the analyzing can include a second request. The receiving and the analyzing can be associated with a request to send data between nodes that have communicated previously, exchanged a substantially similar amount of data, and the like. In embodiments, the selecting a first intermediate node, one or more additional intermediate nodes, etc. can be based on the routing history. The routing history can be used to successfully send data between a first node and a second node without having to recalculate each node selection based on the previously successfully chosen route.

The system 800 can include a computer program product embodied in a non-transitory computer readable medium for communication, the computer program product comprising code which causes one or more processors to generate semiconductor logic for: accessing a system-on-a-chip (SoC), wherein the SoC includes a mesh network, wherein the mesh network comprises a plurality of nodes, wherein at least one node within the plurality of nodes includes a quality-of-service (QoS) agent; collecting network traffic data, by a first QoS agent within a first node within the plurality of nodes, wherein the network traffic data is associated with the first node, and wherein the network traffic data occurs during a first timing window; receiving, by the first QoS agent, a request by a primary device within the first node to send data to a secondary device in a second node within the plurality of nodes; analyzing, by the first QoS agent, the network traffic data; selecting, by a first routing agent within the first node, an intermediate node within the plurality of nodes, wherein the selecting is based on the analyzing; and sending, by the primary device, the data to the intermediate node.

The system 800 can include a computer system for communication comprising: a memory which stores instructions; one or more processors coupled to the memory, wherein the one or more processors, when executing the instructions which are stored, are configured to: access a system-on-a-chip (SoC), wherein the SoC includes a mesh network, wherein the mesh network comprises a plurality of nodes, wherein at least one node within the plurality of nodes includes a quality-of-service (QoS) agent; collect network traffic data, by a first QoS agent within a first node within the plurality of nodes, wherein the network traffic data is associated with the first node, and wherein the network traffic data occurs during a first timing window; receive, by the first QoS agent, a request by a primary device within the first node to send data to a secondary device in a second node within the plurality of nodes; analyze, by the first QoS agent, the network traffic data; select, by a first routing agent within the first node, an intermediate node within the plurality of nodes, wherein the selecting is based on the analyzing; and send, by the primary device, the data to the intermediate node.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system” may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for communication comprising:
accessing a system-on-a-chip (SoC), wherein the SoC includes a mesh network, wherein the mesh network comprises a plurality of nodes, wherein at least one node within the plurality of nodes includes a quality-of-service (QoS) agent;
collecting network traffic data, by a first QoS agent within a first node within the plurality of nodes, wherein the network traffic data is associated with the first node, and wherein the network traffic data occurs during a first timing window;
receiving, by the first QoS agent, a request by a primary device within the first node to send data to a secondary device in a second node within the plurality of nodes;
analyzing, by the first QoS agent, the network traffic data;
selecting, by a first routing agent within the first node, an intermediate node within the plurality of nodes, wherein the selecting is based on the analyzing; and
sending, by the primary device, the data to the intermediate node.

2. The method of claim 1 wherein the SoC includes a second QoS agent within a second node within the plurality of nodes.

3. The method of claim 2 wherein the first QoS agent and the second QoS agent communicate over a separate packetized mesh interface.

4. The method of claim 1 wherein the first node and the second node are non-adjacent within the mesh network.

5. The method of claim 4 wherein the intermediate node is adjacent to the second node.

6. The method of claim 5 wherein the sending is based on an estimated latency.

7. The method of claim 5 wherein the sending includes an accumulated latency associated with the request.

8. The method of claim 5 further comprising forwarding the data from the intermediate node to the second node.

9. The method of claim 4 wherein the intermediate node is non-adjacent to the second node.

10. The method of claim 9 further comprising gathering additional network traffic data, by an intermediate QoS agent within the intermediate node, wherein the additional network traffic data is associated with the intermediate node, and wherein the additional network traffic data occurs during a second timing window.

11. The method of claim 10 further comprising determining, by the intermediate QoS agent, an accumulated latency associated with the request.

12. The method of claim 11 further comprising examining, by the intermediate QoS agent, the additional network traffic data.

13. The method of claim 12 further comprising picking, by an intermediate routing agent, a second intermediate node within the plurality of nodes, wherein the picking is based on the examining.

14. The method of claim 13 wherein the picking is based on the accumulated latency.

15. The method of claim 13 further comprising transmitting, by the intermediate node, the data to the second intermediate node.

16. The method of claim 1 wherein the sending includes an accumulated latency and an estimated latency.

17. The method of claim 16 wherein the sending includes one or more additional intermediate nodes.

18. The method of claim 17 further comprising updating the accumulated latency, by one or more additional QoS agents within each of the one or more additional intermediate nodes.

19. The method of claim 18 further comprising comparing, by the first QoS agent, the estimated latency to the accumulated latency.

20. The method of claim 19 further comprising saving a routing history, wherein the routing history includes the estimated latency, the accumulated latency, the first node, the one or more additional intermediate nodes, and the second node.

21. The method of claim 20 wherein the receiving and the analyzing include a second request, and wherein the selecting is based on the routing history.

22. The method of claim 1 wherein the collecting includes configuring, by the first QoS agent, the first timing window.

23. The method of claim 22 further comprising reconfiguring, by the first QoS agent, the first timing window.

24. The method of claim 23 wherein the reconfiguring is based on an accumulated latency.

25. The method of claim 1 wherein the analyzing includes calculating a rate of change of data bandwidth over the first timing window.

26. A computer program product embodied in a non-transitory computer readable medium for communication, the computer program product comprising code which causes one or more processors to generate semiconductor logic for:
accessing a system-on-a-chip (SoC), wherein the SoC includes a mesh network, wherein the mesh network comprises a plurality of nodes, wherein at least one node within the plurality of nodes includes a quality-of-service (QoS) agent;
collecting network traffic data, by a first QoS agent within a first node within the plurality of nodes, wherein the network traffic data is associated with the first node, and wherein the network traffic data occurs during a first timing window;
receiving, by the first QoS agent, a request by a primary device within the first node to send data to a secondary device in a second node within the plurality of nodes;
analyzing, by the first QoS agent, the network traffic data;
selecting, by a first routing agent within the first node, an intermediate node within the plurality of nodes, wherein the selecting is based on the analyzing; and
sending, by the primary device, the data to the intermediate node.

27. A computer system for communication comprising:
a memory which stores instructions;
one or more processors coupled to the memory, wherein the one or more processors, when executing the instructions which are stored, are configured to:
access a system-on-a-chip (SoC), wherein the SoC includes a mesh network, wherein the mesh network comprises a plurality of nodes, wherein at least one node within the plurality of nodes includes a quality-of-service (QoS) agent;
collect network traffic data, by a first QoS agent within a first node within the plurality of nodes, wherein the network traffic data is associated with the first node, and wherein the network traffic data occurs during a first timing window;
receive, by the first QoS agent, a request by a primary device within the first node to send data to a secondary device in a second node within the plurality of nodes;
analyze, by the first QoS agent, the network traffic data;
select, by a first routing agent within the first node, an intermediate node within the plurality of nodes, wherein the selecting is based on the analyzing; and
send, by the primary device, the data to the intermediate node.
